(19) United States
(12) Patent Application Publication
(10) Pub. No.: US 2007/0125885 A1
(43) Pub. Date: Jun. 7, 2007

(54) Spray apparatus

(76) Inventors: David Daly, London (GB); Alan Ennis, Godstone Surrey (GB)

Correspondence Address: BLANK ROME LLP, 600 NEW HAMPSHIRE AVENUE, N.W., WASHINGTON, DC, 20037, US

(21) Appl. No.: 10/564,468

(22) PCT Filed: Jul. 14, 2004
(86) PCT No.: PCT/GB04/03061

§ 371 Date: Nov. 22, 2006

(30) Foreign Application Priority Data
Jul. 15, 2003 (GB) 0316523.0

(51) Int. Cl. B05B 9/01

(52) U.S. Cl. 239/526; 239/208; 239/548

(57) ABSTRACT

Spray apparatus for cleaning inter alia toilet bowls comprises a spray head connected through a water hose to a pressurised source of water. The spray head includes a casing formed with an opening to receive one end of the water hose and an outlet nozzle form which water under pressure can leave the housing. A hand operated valve is provided for selectively enabling or preventing the flow of water through the outlet nozzle.

This invention relates to spray apparatus for cleaning inter alia toilet bowls, urinals and bidets where hygiene is paramount. For ease of reference these items will be referred to below as toilet bowls.

Conventionally brushes are used in houses, hotels and elsewhere to clean the surfaces of toilet bowls. Whereas these brushes may well adequately clean a toilet bowl, they in themselves harbour germs and other debris to the potential harm of people or children who come into contact with them.

The present invention set outs to provide an alternative non contact cleaner for toilet bowls which overcomes, or at least alleviates, many of the disadvantages present in existing toilet bowl cleaners.

In one aspect, the invention provides spray apparatus for cleaning inter alia toilet bowls, the apparatus comprising a spray head connected through a water hose to a pressurised source of water, the spray head including a casing formed with an opening to receive one end of the water hose and an outlet nozzle from which water under pressure can leave the housing, and a hand operated valve for selectively enabling or preventing the flow of water through the outlet nozzle.

The cross-sectional area of the outlet nozzle is preferably substantially less than that of the hose and/or the opening in communication with the hose. Typically, the cross-sectional area of the outlet nozzle is less than one half that of the hose.

The outlet nozzle may comprise a single orifice or a plurality of such orifices typically in the form of a compact pattern. In a preferred arrangement, four orifices are provided.

A chamber may be housed within the casing to receive and retain cleansing medium. The cleansing medium may comprise a cleansing tablet, e.g. an anti-microbial tablet.

The valve may be operated manually by a trigger mounted externally on the spray head casing. The valve may be resiliently biased to its closed position. That is to say, the outlet nozzle of the spray head is only placed in communication with the pressurised source of water through operation of the trigger by, for example, finger pressure. The biasing of the valve may be effected by a coil spring.

The water hose is preferably flexible and may be produced from plastics, rubber or rubber-like material. The hose wall may be reinforced with metallic wire or filaments.

The spray head is preferably produced from plastics and may include a removable cover to provide access to the chamber. Materials other than plastics may however be employed.

The hose is preferably connected to the head through a friction fit over a collar protruding from one side of the casing. The external surface of the hose may be corrugated.

The source of pressurised water may comprise a pipe connected to a mains supply to a building. Alternatively, the pipe may receive water from an elevated holding tank positioned within a building. Alternatively, the pipe may receive water from a pipe connected to receive water under pressure from, for example, an electrically or mechanically driven pump. In one arrangement, the pipe comprises a water feed pipe for conveying water under pressure to a cistern of a toilet. The connection between the hose and the water pipe may comprise a conventional bifurcated or similar connector.

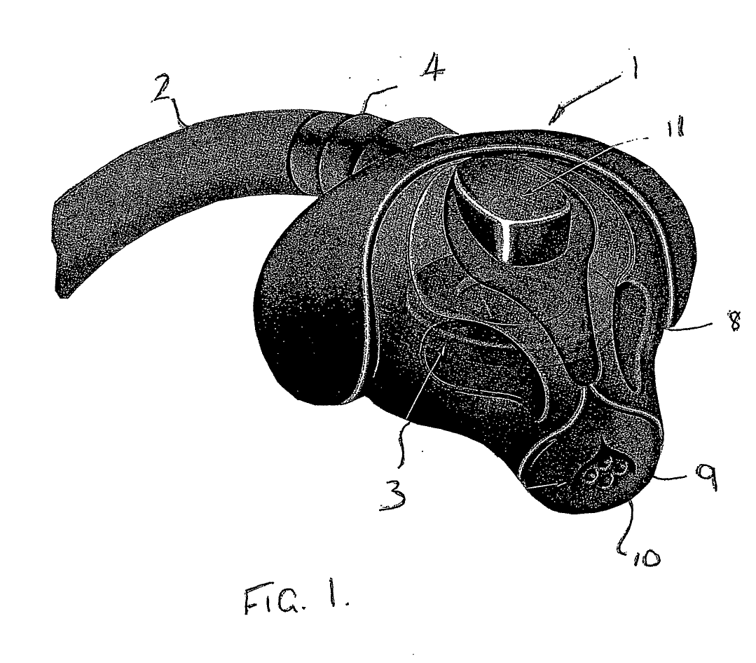

The invention will now be described by way of example only, with reference to the accompany diagrammatic drawing of spray apparatus in accordance with the invention, in which FIG. 1 is a perspective view of spray apparatus in accordance with the invention.

The illustrated apparatus comprises a spray head 1 connected to a water hose 2. The spray head has a casing 3 and the hose 2 includes a corrugated end piece 4 which projects into an inlet orifice of the casing 3. The hose defines a friction fit within the inlet orifice of the casing. The casing 3 houses a chamber including a compartment in which is positioned a cleansing tablet. This tablet may comprise and anti-microbial tablet.

The casing has a removable lid 8 to provide access to the chamber.

In use, the chamber is flooded with water entering the casing through the inlet orifice, the water leaving the casing through an outlet nozzle 9 positioned in the side of the casing 3 remote from the inlet orifice. The outlet nozzle carries a series of orifices 10. The sum of the cross-sectional areas of the orifices 10 is substantially less than that of the hose and/or the inlet orifice, typically the total area of the outlet nozzle is less than half that of the hose and/or the inlet orifice.

The flow of water through the casing is controlled by a valve operable by a trigger 11 positioned on the external surface of the spray head. The trigger 11 is typically operated by finger pressure. The valve is biased to a position in which it prevents the flow of water to the outlet nozzle. Thus, operation of the trigger enables water to pass from the hose, through the casing and then to the outlet nozzle.

A rod-shaped extension piece may be connected to the spray head to enable the jets of water leaving the nozzle orifices 10 to be directed at locations within a toilet bowl and even below the surface of water retained in the bowl. The extension piece preferably includes a plurality of generally parallel bores, each receiving water from one of the outlet orifices of the spray head. One end of the extension piece may be formed with a screw thread which cooperates with a complementary thread of the spray head. Other ways of removably mounting the extension piece onto the spray head may be used.

The end of the hose 2 remote from the spray head is connected via a conventional bifurcated coupling to a pipe connected to receive water from a pressurised source. Typically this source comprises a mains supply or a header tank of a building. It may alternatively comprise a supply of water pumped to the pipe by an external electronically or mechanically operated pump.

The respective dimensions of the hose, the inlet orifice and the outlet nozzle are selected to ensure that water leaving the spray head does so at a pressure sufficient to effect satisfactory cleaning of the toilet bowl.

When not in use, the spray head is simply mounted close to the respective toilet bowl. For use, it is simply lifted and the nozzle directed towards the bowl interior and the trigger operated to provide effective cleansing thereof. After use, the spray head is simply returned to its inoperative position. Because there is no contact between the spray head and the bowl interior, problems normally associated with toilet bowl brushes are avoided.

It will be appreciated that the foregoing is merely exemplary of spray apparatus in accordance with the invention and that various modifications can readily be made thereto without departing from the true scope of the invention described.

1. Spray apparatus for cleaning inter alia toilet bowls, the apparatus comprising a spray head connected through a water hose to a pressurised source of water, the spray head Including a casing formed with an opening to receive one end of the water hose and an outlet nozzle from which water under pressure can leave the housing, and a hand operated valve for selectively enabling or preventing the flow of water through the outlet nozzle.

2. Apparatus as claimed in claim 1 wherein the cross-sectional area of the outlet nozzle is substantially less than that of the hose and/or the opening in communication with the hose.

3. Apparatus as claimed in claim 2 wherein the cross-sectional area of the outlet nozzle is less than one half that of the hose.

4. Apparatus as claimed in claim 1 wherein the outlet nozzle comprises a single orifice.

5. Apparatus as claimed in claim 1 wherein the outlet nozzle comprises a plurality of orifice.

6. Apparatus as claimed in claim 1 wherein a chamber is housed within the casing to receive and retain cleansing medium.

7. Apparatus as claimed in claim 1 wherein the valve is operated manually by a trigger mounted externally on the spray head casing.

8. Apparatus as claimed in claim 7 wherein the valve is resiliently biased to its closed position.

9. Apparatus as claimed in claim 1 wherein the water hose is flexible.

10. Apparatus as claimed in claim 9 wherein the water hose is produced from plastics or rubber or a rubber-like material.

11. Apparatus as claimed in claim 9 wherein the hose wall is reinforced with metallic wire or filaments.

12. Apparatus as claimed in claim 1 wherein the spray head includes a removable cover to provide access to the chamber.

13. Apparatus as claimed in claim 1 wherein the hose is connected to the head through a. friction fit over a collar protruding from one side of the casing.

14. Apparatus as claimed in claim 1 wherein the external surface of the hose is corrugated.

15. Apparatus as claimed in claim 1 wherein the source of pressurised water comprises a pipe connected to a mains supply to a building.

16. Apparatus as claimed in claim 1 wherein the pipe receives water from an elevated holding tank positioned within a building.

17. Apparatus as claimed in claim 1 wherein the pipe receives water under pressure from an electrically or mechanically driven pump.

18. Apparatus as claimed in claim 1 wherein the pipe comprises a water feed pipe for conveying water under pressure to a cistern of a toilet.

19. (canceled)
